(19) United States
(12) Patent Application Publication
(10) Pub. No.: US 2021/0373596 A1
(43) Pub. Date: Dec. 2, 2021

(54) VOICE-ENABLED EXTERNAL SMART PROCESSING SYSTEM WITH DISPLAY

(71) Applicant: TALKGO, INC., Mercer Island, WA (US)

(72) Inventors: Chandler Murch, Mercer Island, WA (US); Andrew Angelo DeLorenzo, Mercer Island, WA (US)

(21) Appl. No.: 17/397,405

(22) Filed: Aug. 9, 2021

Related U.S. Application Data
(63) Continuation-in-part of application No. 16/837,759, filed on Apr. 1, 2020.
(60) Provisional application No. 62/828,240, filed on Apr. 2, 2019.
(60) Provisional application No. 63/063,122, filed on Aug. 7, 2020.

(51) Int. Cl. G06F 1/16; G10L 15/22; G06F 3/16; G06F 1/3206

(52) U.S. Cl. CPC G06F 1/1605; G10L 15/22; G06F 3/167; G06F 1/165; G10L 2015/223; G06F 1/1688; G06F 1/1607; G10L 2015/225; G06F 1/3206

(57) ABSTRACT

A voice-enabled external smart battery processing system is provided. At least one sensor includes a microphone and is configured to identify an input audio signal from a user. A low-power processor is configured to process the input audio signal and initiate a voice assistant session for a host device. A battery is configured to provide power to the processor and the host device, while a display provides visual output based on the input audio signal.

### CROSS-REFERENCE TO RELATED APPLICATIONS

This non-provisional patent application is a continuation-in-part of U.S. patent application Ser. No. 16/837,759, filed Apr. 1, 2020, pending, and further claims priority under 35 U.S.C. § 119(e) to U.S. Provisional Patent application, Ser. No. 63/063,122, filed Aug. 7, 2020, the disclosures of which are incorporated by reference.

### FIELD

The present disclosure relates generally to displays and in particular, to a voice-enabled external smart processing system with display.

### BACKGROUND

Today's mobile battery cases provide continuous power when connected to a host device such as a mobile phone. This is connection is generally controlled by analog means, for example through physical buttons, switches, and light emitting diode (LED) indicators. This approach works for lower-bandwidth applications running on traditional host devices such as cellphones, fitness trackers, cameras, motion detectors, and global positioning system (GPS) devices, as the data gathering process associated with such lower-bandwidth applications can be turned on and off to save power without impacting the applications running on the host device. For higher-bandwidth applications, however, such as voice-related signal processing applications, such as digital personal assistants like Siri, Google Assistant, or Alexa, all sound input is critical and must be continually processed. As a result, duty cycling (i.e., powering the host device on and off) is impractical when such voice-related applications are being utilized. Moreover, third-party applications lack access to the operating system (OS) of the host device to enable more sophisticated control of the host device. For signal processing applications like this, the primary limiting factor for executing such an application external to the host device is the power required to continually digitize all of the audio or sound signals in order to analyze these audio signals to detect voice signals and to subsequently process these voice signals to detect spoken wake words and commands. This type of processing external to the host device is difficult without controlling the entire hardware and software stack of the host device.

Accordingly, what is needed is a system and method for providing consumers with the freedom to choose the digital personal assistant application they prefer to utilize independent of the type of host device or operating system running on the host device. Preferably, an external device with a personal assistant is attached to the host device and works to communicate with and control the host device, and display output from the host device via a display.

### SUMMARY

A low-power external system can allow third-party digital personal assistants to run on any device, even those that have previously been limited to proprietary hardware and software stacks. For example, Amazon's Alexa digital personal assistant could run always listening on an Apple iPhone that would normally only be able to have Siri always activated or listening, with the phone on and fully powered.

Embodiments of the present disclosure allows consumers the freedom to choose their desired always-listening digital personal assistant, regardless of the type of host device or operating system running on that device.

Embodiments of the present disclosure generally relate to the use of low-power voice, audio, vibration, touch, or proximity sensing triggers to control operation of a host device via an external intuitive user interface (e.g., a phone case) that includes circuitry that receives such low-power voice, audio, vibration, touch, or proximity sensing triggers. Embodiments of the interface will work in situations where traditional interfaces are inconvenient and are limited by onboard and often proprietary hardware and software of the host device. More particularly, embodiments of the interface utilize low-power voice triggers to control operation of host devices, and to automatically adapt routing of host device audio streams to optimize life and health of a battery of the host device via smart low-power secondary batteries, processors, and microphones in the external system.

A further embodiment provides a voice-enabled external smart battery processing system. At least one sensor includes a microphone and is configured to identify an input audio signal. A low-power processor is configured to process the input audio signal and initiate a voice assistant session for a host device. A battery is configured to provide power to the processor and the host device, and a speaker provides feedback in response to the input audio signal. Further, a display is configured to provide visual output based on the input audio signal.

A still further embodiment provides a smart battery system including an external system. The external system includes at least one sensor with a microphone and is configured to identify an input audio signal. A processor is configured to process the input audio signal and initiate a voice assistant session for a host device in a standby or off mode of operation. The host device is associated or paired with the external system. A battery is configured to provide power to the processor and the host device, and a speaker provides feedback from the host device in response to the input audio signal. A display is affixed to an outer surface of the external system and configured to provide visual output based on the input audio signal.

### BRIEF DESCRIPTION OF THE DRAWINGS

FIG. 1 is a block diagram illustrating external systems contained within a case attached to a host device according to embodiments of the present disclosure.

FIG. 2 is a functional block diagram illustrating the external system of FIG. 1 in more detail according to an embodiment of the present disclosure.

FIG. 3 is a flowchart illustrating operation of the external system of FIG. 2 according one embodiment of the present disclosure.

FIG. 4 is a perspective view of an embodiment of a voice-enabled external smart battery processing system of FIGS. 1 and 2 according to another embodiment of the present disclosure; and

FIG. 5 is a functional block diagram showing, by way of example, a system for communication between the external system and host device of FIG. 1.

FIG. 6 is a perspective view 600 of a voice-enabled external smart battery processing system of FIGS. 1 and 2 with a display and affixed to a mobile device.

FIG. 7 is a block diagram showing, by way of example, an exploded view of the voice-enabled external smart battery processing system 601 of FIG. 6.

FIG. 8A-D are block diagrams of different content displayed by the display of the processing system of FIG. 6.

FIGS. 9A-D are block diagrams, showing by way of example, different housings or frames to hold the processing system.

### DETAILED DESCRIPTION

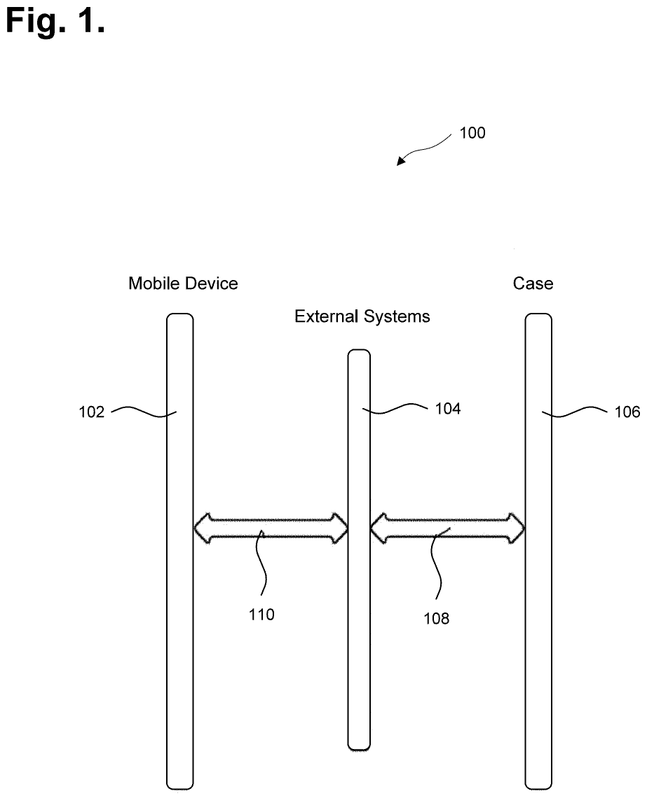

A smart battery system 100 according to an embodiment of the present disclosure is represented through the block diagram of FIG. 1. The system 100 provides for monitoring and control of a mobile and Internet-of-Things (IoT) type of device 102, referred to herein as a “host device,” through a voice-enabled external smart battery processing system 104, referred to hereinafter as an “external system,” which is physically contained in a smart battery case 106 housing the host device. This physical containment or housing of the external processing system 104 in the case 106 is represented through an arrow 108 in FIG. 1, and may also be referred to as a mechanical interface. The physical housing may be custom designed for a particular host device or type of host devices. The host device 102 would also typically be physically contained or housed in the case 106, such as where the host device is a smart phone. Other types of host devices are possible, including tablets, speakers, vehicle audio systems, and ear buds or headphones.

The external processing system 104 includes components for providing low-power “always on” audio, movement, biometric, proximity, and/or location signals, and includes an external battery (not shown). The external system 104 provides these signals while a host processor in the host device 102 is in a standby or off mode of operation. Additionally, the external system 104 may be configured to identify a predetermined input pattern in the audio, movement, biometric, proximity, and/or location signals. In response to detecting the predetermined pattern, the external system 104 triggers or initiates a voice assistant session with respect to the host device 102. This voice assistant session may include launching or initiating execution of applications both in the host device 102 as well as in the external system, as will be described in more detail below. For host devices not already voice-enabled, the external system allows those devices to become voice-enabled by providing a voice assistant.

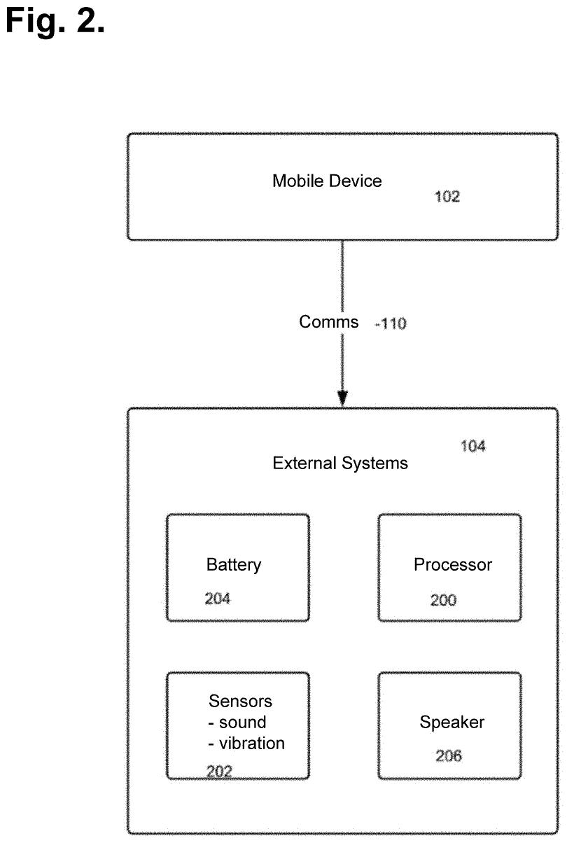

In embodiments of the present disclosure, the smart battery case 106 includes the components of the external system 104 which include a low-power always listening microphone, and a low-power processor typically implemented in a digital signal processor (DSP). The low-power intelligently aware processor is configured to control coupling of the external battery in the external system 104 to power the host device 102 and is further configured to operate to accept “wake word” commands from a user as well as to interact with local applications running on the host device 102. For instance, a communication interface 110 of the external system 104 may be coupled to the host device 102 to provide the low-power processor access to an internal operating system (OS) of the host device 102, which, in tum, enables the low-power processor to communicate with and control the host device. The host device 102 can then transmit and receive signals through the communication interface 110 with the low-power processor in the external system 104, and in this way the host device can receive detected speech and/or movement signals from the sensors in the external system 104. Likewise, as will be described in more detail with reference to FIG. 2, the low-power processor in the external system 104 may be coupled to additional interfaces in the external system to collect information from the various sensors in the external system, and to provide the collected information via the communication interface 110 to the host device 102 to optimize usage and availability of internal battery of the host device. In one example, the low-power processor in the external system 104 is adapted to execute one or more instructions under control of the host device, a user's voice responsive to signals from the sensors in the external system, or a location of the host device or movement of the host device provided to the low-power processor via the communication interface 110.

The host device 102 is considered part of the smart battery system 100 in FIG. 1, and thus the present description may alternatively refer to the smart battery system or the host device 102 during voice assistant sessions. In addition to generating the audio output signal during a device voice assistant session, the host device 102 may provide additional user feedback, such as, for example, vibrating, generating visual lighting cues or audio effects, and providing other programmable feedback (e.g., notifying one or more other devices or accounts associated with the user or a contact of the user) to assist the user during the voice assistant session.

Referring to FIG. 2, a functional block diagram illustrates the external system 104 of FIG. 1 in more detail according to one embodiment of the present disclosure. FIG. 2 shows the host device 102 and the external system 104 of FIG. 1. The external system 104 includes a low-power processor 200 that functions as a firmware solution to enable low-power operation of the external system while a host processor (not shown) in the host device 102 remains in a standby or off mode. The low-power processor 200 includes a monitor module that executes to monitor an input audio signal from one or more sensors 202 contained in the external system 104. To generate the audio signal that is monitored by the low-power processor, the sensors 202 include a microphone that generates the audio signal while the host device 102 is in the standby or off mode. The external system 104 further includes an external battery 204 (external to the host device) that is used to power the low-power processor 200 and other components in the external system, as well as to provide power to the host device 102 under control of the low-power processor. A speaker 206, or other suitable type of audio transducer, in the external system 104 provides audible feedback to a user under control of the low-power processor 200 during a voice assistant session.

The low-power processor 200 monitors an audio signal from the microphone contained in the sensors 202, and in response to detecting a predetermined pattern in the audio signal the low-power processor triggers a voice assistant session for the host device 102.

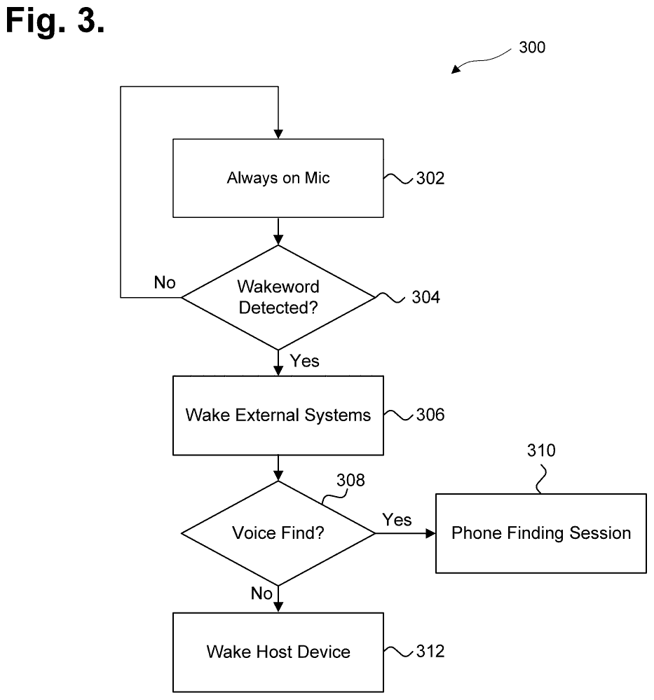

A method of low-power activation of an external intelligent digital personal assistant is shown in the flowchart of FIG. 3. The method may be implemented as a set of computer instructions stored in in the low-power processor 200 or other memory in the external system 102. To implement this method, the external system 104 may include a MEMS microphone in the sensors 202, and may include analog or mixed-signal processors (RAMP) digital signal processors (DSP) for implementing the low-power processor 200, along with a suitable machine- or computer-readable storage medium such as random access memory (RAM), read only memory (ROM), programmable ROM (PROM), flash memory, and so on in the external system. The external system 104 could also include suitable configurable logic such as, for example, programmable logic arrays (PLAs), field programmable gate arrays (FPGAs), complex programmable logic devices (CPLDs), fixed-functionality hardware logic using circuit technology such as, for example, application specific integrated circuit (ASIC), a microcontroller, or any combination thereof, to implement the desired functionality of the low-power processor 200. For example, computer program code to execute on the low-power processor 200 and carry out desired operations may be written in any combination of one or more programming languages, including an object oriented programming language such as Java, Smalltalk, C++ or the like and conventional procedural programming languages, such as the “C” programming language or similar programming languages, as will be appreciated by those skilled in the art.

The flowchart in FIG. 3 shows a process 300 for monitoring an input audio signal that is executed by the low-power processor 200 (FIG. 2) in the external system 104 while the host processor of the host device 102 is in a standby or off mode of operation. The process of monitoring the input audio signal would typically involve implementing the process in a low-power solution that minimizes the potential impact on power consumption or battery life of the battery 204. For example, in one embodiment the low-power processor 200 is a digital signal processor (DSP) operating at a relatively low frequency which samples the input audio signal for the sensors 202 on an intermittent basis and reduces the power consumption of the external system 104. In operation, the low-power processor 200 senses the input audio signal from a microphone or other suitable sensor in the sensor 202.

Referring to FIGS. 2 and 3, the process 300 begins in step 302 in which a microphone or other suitable sensor in the sensors 202 generates the input audio signal in response to sensed sound in the environment in which the smart battery system 100 is located. From step 302, the process 300 proceeds to step 304 and the low-power processor 200 executes an audio module to process the input audio signal and determine whether the wake word has been detected. The wake word can be the name of a voice assistant associated with a voice-enabled interface of the external system or another command recognized by the voice assistant. If the determination in step 304 is negative, the process goes back to step 302 and the audio module continues to execute to process the input audio signal from the sensors 202.

When the determination in step 304 is positive, the audio module has determined the wake word has been spoke and the process 300 proceeds to step 306. In step 306, the low-power processor 200 executes suitable control modules to control activation of desired circuitry in the external system 104, such as audio output circuitry associated with the speaker 206. From step 306, the process 300 proceeds to step 308 and the low-power processor 200 executes a module to process the detected audio pattern in the input audio signal to determine the appropriate action to be taken. For example, if the wake word “Alexa” is detected in step 304 and then in step 308 the audio pattern “Help me locate you” is detected in step 308, the determination in step 308 is positive and the process 300 then proceeds to step 310 to implement a device location session to help the user locate the host device 102. Conversely, if the process 300 detects alternative language in step 308, the process proceeds to step 312 and another action is taken, such as the low-power processor 200 executing a module to communicate over the communication interface 110 with the host device 104 to thereby cause the host device to take a desired action, such as activating or “waking” the host device, or activating and interacting with a personal assistant of the host device.

The trigger for initiating a voice assistant session for the host device 104 is based on the predetermined audio pattern, which may be selectively configurable. For example, if the predetermined audio pattern is a command such as “Help me locate you,” the device location session is initiated in step 310 and may include generating an output audio signal (e.g., tone, beacon) that is supplied to the speaker 206 to generate a sound that may be audibly followed by the originator/source (e.g., user) in order to help the user locate the host device 102. The process 300 may be conducted through the circuitry of the external system 104 without activating the host processor or OS of the host device 102, for example. In embodiments of the external system 104, the low-power processor 200 may be configured to recognize a relatively small number of predetermined audio patterns (e.g., five) without negatively impacting power consumption external system 104.

In an embodiment of the external system 104, the low-power processor 200 is configured to recognize only a single predetermined audio wake word pattern in order to thereby achieve a lower power consumption of the low-power processor and external system 104, extending the battery life of the external battery 204 and thereby the external system.

In embodiments of the present disclosure, the low-power processor 200 may include a low-power audio driver module that receives an inter-processor communication (IPC) from the low-power processor 200 once the processor has been taken out of the standby mode. On receiving the IPC, the low-power audio driver module may send a notification (e.g., voice trigger event) to a speech dialog application executing on the low-power processor 200. The speech dialog application may in tum open an audio capture pipeline via the audio driver module using an OS audio application programming interface (API). The speech dialog application may also start a speech interaction with a user via an audio, visual or touch output stream. The output streams may include one or more speech commands and/or responses that are transferred between the applications, devices and the user. The output audio signal containing the responses may be made audible to the user via an onboard speaker (e.g., hands free loudspeaker, embedded earpiece, etc.). As will be discussed in greater detail, the output audio signal may be routed to the onboard speaker even if a wireless audio accessory such as a Bluetooth (e.g., Institute of Electrical and Electronics Engineers (IEEE) 802.15.1-2005, Wireless Personal Area Networks) headset is connected to the host device.

In another embodiment of the present disclosure, the low-power processor 200 is further configured to provide a voice-enabled interface to enable a user to communicate with and control the host device 102 through this voice-enable interface that is implemented through the external system 104 contained in the case 106. In this way, a user can select the desired voice-enabled interface that the user will utilize to interact with the host device 102. For example, the voice-enabled interface through the external system 104 and case 106 may correspond to the Siri interface that is provided with Apple devices, even though the host device 102 contained in the case and coupled to the external system is an Android device. In this way, a user can select the desired voice-enabled interface, namely can select the desired digital personal assistant which the user will utilize to interact with his or her host device 102.

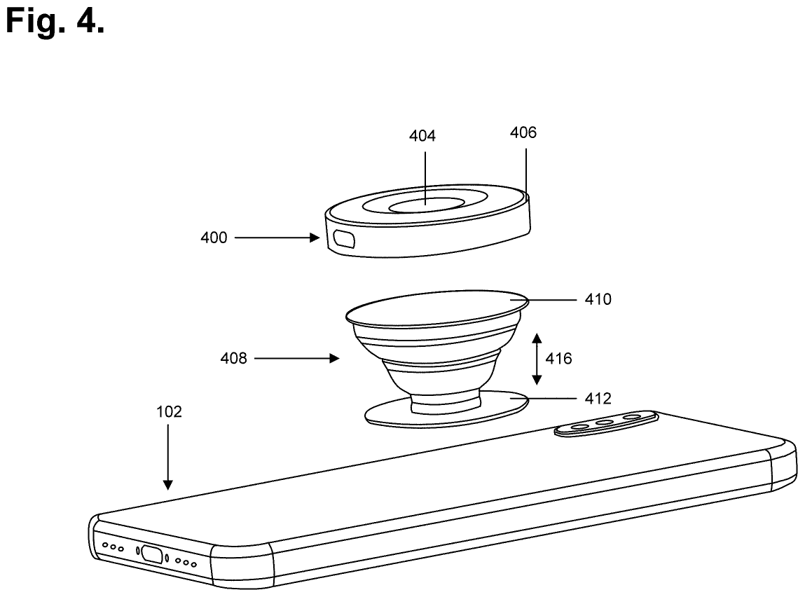

FIG. 4 is a perspective view of a voice-enabled external smart battery processing system 400 according to another embodiment of the present disclosure. The voice-enabled external smart battery processing system 400 may correspond to an example embodiment of the external system 104 shown and described above with reference to FIGS. 1 and 2. The voice-enabled external smart battery processing system 400 is configured to attach and communicate with a host device 102 as described above with reference to FIGS. 1 and 2, with the host device being a smart phone in the example embodiment of FIG. 4. In operation, the voice-enabled external smart battery processing system 400 is configured to provide a voice-enabled interface to enable a user to communicate with and control the host device 102.

To enable a user to activate the voice-enabled interface, the processing system 400 may include an activation button 404 that is depressed by a user to enable the voice-enabled interface to receive voice commands. In other implementations, the system 400 may be configured to be in an “always listening” mode wherein the user is not required to depress an activation button before operating the system. In at least some implementations, a light ring 406 surrounds the activation button 404 and illuminates to indicate to the user the status of the voice-enabled interface. In one embodiment, the voice-enabled interface is the Alexa digital personal assistant from Amazon, although it should be appreciated that the system may be operable to work with numerous available personal digital assistants. In at least some implementations, the system 400 allows the user to select a desired voice-enabled interface independent of the type of host device 102 to which the system is attached, and thus the Alexa interface could be utilized even where the host device is a device such as an iPhone from Apple having the Siri digital personal assistant resident on the host device.

In the embodiment of FIG. 4, the detachable interface device 408 is configured to provide mechanical functionality for the user in holding the processing system 400 and associated host device 102, as will now be described in more detail. The detachable interface device 408 includes an expandable grip 410 (e.g., telescoping grip) coupled to an attachment base 412 that is configured to be selectively coupled to the associated host device 102. In the example embodiment of FIG. 4, the processing system 400 may be wirelessly coupled to the host device 102, with the interface device 408 functioning merely to physically attach the processing system 400 to the associated host device 102 in such an embodiment. The interface device 408 can be affixed on one end to the processing system 400 via an adhesive material or as molded directly to the processing system. Similarly, the other end of the interface device 408 can be affixed to the host device 102 via adhesive material.

In operation, the expandable grip 410 is expandable upward and contractible downward as indicated by the arrows 416 in FIG. 4. The grip 410 is expanded upward to allow the user to physically hold the processing system 400 and host device when being utilized by the user, or to be utilized as a stand when placed on a flat surface to allow the user to more easily view a screen of the host device. This mechanical functionality of the detachable interface device 408 may be similar to that provided by grip and stand devices such as Popsocket grips currently available for smart phones and other electronic devices. However, other types of interface devices, which attach the processing system 400 to the host device 102, are possible.

In another embodiment, the expandable grip 410 can be excluded and the processing system 400 coupled directly to the attachment base 412. Alternatively, the processing system 400 can be directly attached to the host device 102 or a case 106 of the host device 102.

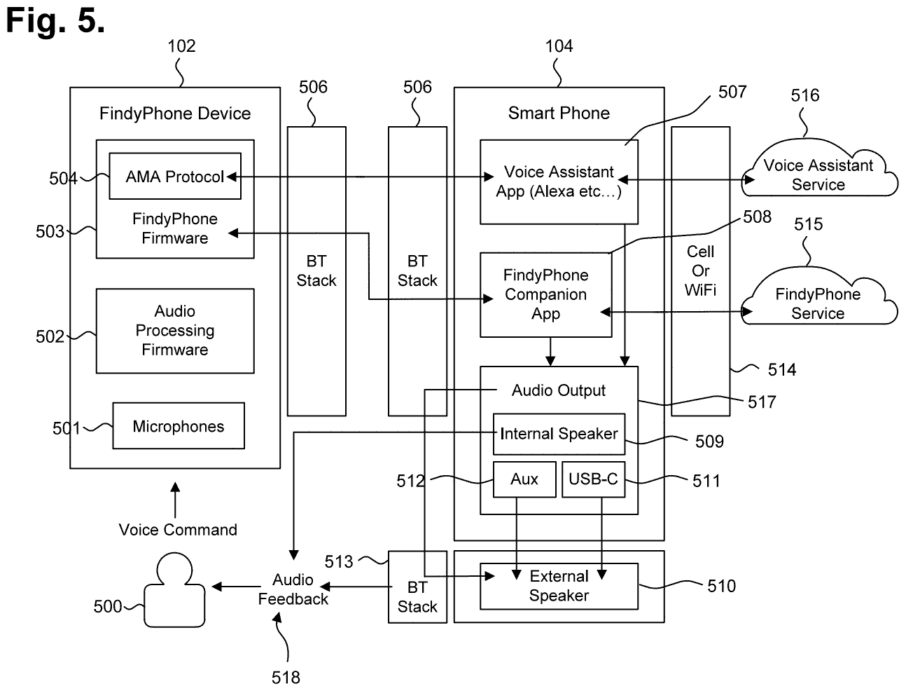

FIG. 5 is a block diagram showing, by way of example, a system for communication between the external system and host device of FIG. 1. A user 500 of a mobile device, such as the host device 102, speaks a command. The host device 102 is associated with an external system 104 that includes at least one microphone 501, audio processing firmware 502, and communication firmware 503 with one or more communication protocols, such as the Alexa Mobile Accessory (AMA) protocol 504. Other types of communication protocols are possible.

In response to the command, the microphone 500 generates an input audio signal for the command, which is received by audio processing firmware 502 to initiate processing of the command. Specifically, the audio processing firmware 502 determines whether a wake word has been detected via the command. If so, the communication firmware 503 communicates with a communication companion application 508 installed on the host device 102 via Bluetooth communication using Bluetooth stacks 506. The companion application 508 accesses communication services 515 via a cellular or WiFi connection 514. The communication services 515 can confirm the user's identity via a unique user account, add new host devices, or depending on the command from the user perform an activity as requested in the command. For example, the command can instruct the host device 102 to emit a sound via an audio output module 517 to allow the user to locate the host device 102. Other types of activities are possible.

The communication firmware 503 also initiates a voice-enabled communication protocol 504, such as AMA protocol, which communicates with a voice assistant application 507 downloaded on the host device 104. Other voice-enabled communication protocols are possible. The voice assistant application 507 then contacts a voice assistant service 516 via a cellular or WiFi connection 514 to perform activities requested by the user in the command. Such activities can include conducting a search for information, sending a message to a recipient, emitting an auditory signal for the user to locate the host device, or identifying a song for playback, as well as other types of activities.

Feedback from the voice assistant service 516 and communication service 515, in response to the command, can be provided to the user via the audio output module 517. The audio output module 517 includes an internal speaker 509 and one or more connector systems, including an Aux connector 512 and USB-C connector 511, to connect to an external speaker or other devices, such as wired headphones. Other types of connectors are possible based on the host device. In a further embodiment, the external speaker or other external devices, such as wireless ear buds and vehicle communication systems, can be connected via Bluetooth 513. The internal speaker 509 of the host device 104 and the external speaker 510 can each output audio feedback 518 to the user 500.

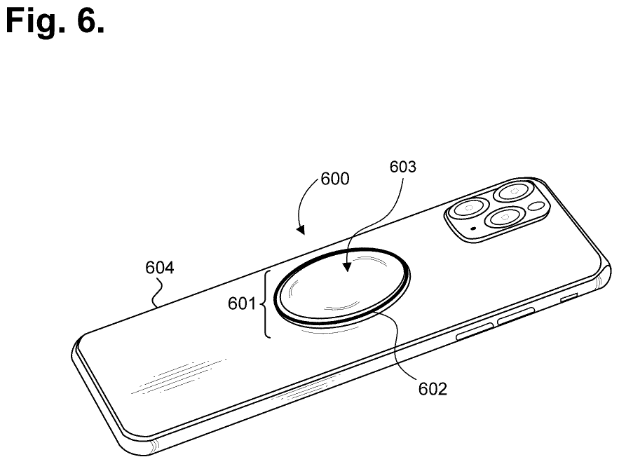

The processing system can be incorporated into a host device itself or can be a separate device that is attached to or associated with the host device. When separate, the external processing system, such as described in FIG. 4, can include a display on a top or outward surface to provide visual content from the mobile device, as well as other types of visual indicators. FIG. 6 is a perspective view of a voice-enabled system 600 with an external smart battery processing system 601 of FIGS. 1 and 2 with a display that is affixed to a mobile device. The processing system 601 can be associated with a host device, such as a mobile phone 604, and can include a display 603 and a light bar 602. A feedback button (not shown) can be provided on perimeter of the display 603 to allow users to respond or provide feedback via the button. Other locations for the feedback button are possible. The button can be pressed by a user in response to content on the display or to turn off the display.

The display 603 can provide temporary or static images and can be a black and white e-paper, CRT, LCD, LED, or OLED display. Other types of displays are possible. A size of the display 603 can be dependent on a size of the processing system 601 and can cover a portion of or the whole top or outward surface of the processing system. The shape of the display 603 can be a square, rectangle, circle, oval, or any other shape, and can be a same or different shape than the top or outward surface of the processing system 601. The light bar 602 can be in the form of a shape that outlines the display 603 and lights up during processing of input audio data, as well as upon receipt of a notification. Other locations and shapes of the light bar 602 are possible.

The display can be utilized to provide visual content to a user via voice-activated commands when the mobile device is asleep. For instance, a user speaks a command that is received through a microphone (not shown) of the processing system 601 and a determination is made as to whether the command is merely external noise or speech. In one example, the command is determined to be speech when the command includes a “wake” word, which the processing system recognizes. Upon receipt of the command, the light bar 602 can light up to indicate that the audio command is received.

When the command is determined to be speech, the external processing system 601 listens locally and caches the audio input. Additionally, the processing system generates a signal that is transmitted to a computer application downloaded on the mobile device, such as by Bluetooth or other wireless mode of transmission. The computer application can include a game, music, book, learning, banking, or any other type of computer application as further discussed below.

The application processes the audio input and provides an audio response that is output via headphones or a speaker of the mobile device 604. Prior to, after, or concurrent with the audio output, visual output can be transmitted via Bluetooth for providing on the display of the processing device 601. The application identified by the “wake” word can determine which visual to provide, such as based on the audio input received. For example, when the command is a request for a song to be played, the music application can send the lyrics of the song to be displayed while the audio of the song plays. Alternatively, the visual can include the name of the song being played and the band or singer of the song.

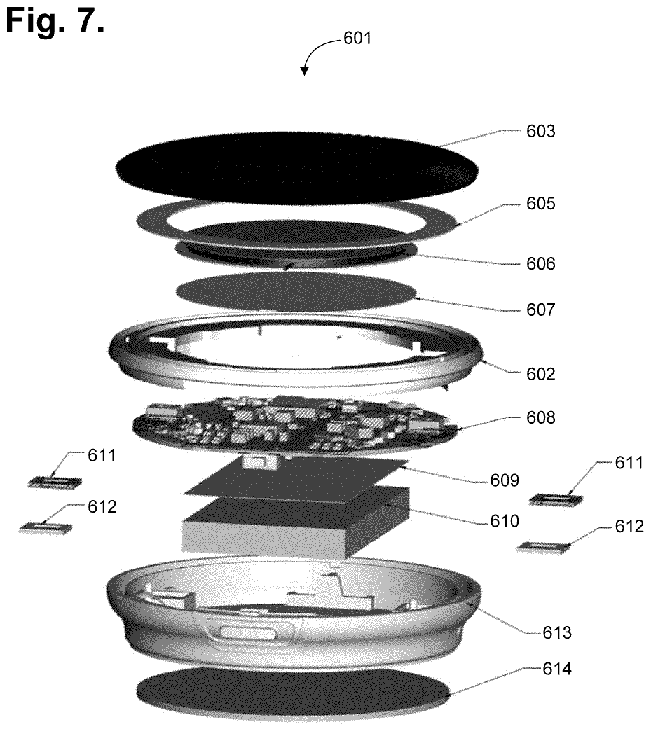

The display can be powered by a battery on the external processing system. FIG. 7 is a block diagram showing, by way of example, an exploded view of the voice-enabled external smart battery processing system 601 of FIG. 6. The external processing system 601 includes a display 603, which is positioned on an outer surface, opposite a host device (not shown), if the external processing system 601 is attached to a host device. The display 603 can fit on or within a frame or seal 605. A charging coil 606 is positioned below the display 603 to provide power to the host device via a battery. A spacer 4, such as a non-conductive, insulating material can be positioned under the coil to shield electronics positioned on a printed circuit board assembly 608.

The printed circuit board 608 can include a microphone and battery, as well as a microcontroller with Bluetooth. The microcontroller can run software that drives a connection of the external processing system 601 with the host device, including a voice assistant. Covers 611, 612 for the microphone can include a waterproof material to protect the microphone, while preventing water, but allowing sound to pass through. A cover, such as tape 609, can also be used to protect a battery 610. A light pipe 602, such as made from plastic or another material, can be positioned over or around the printed circuit board 608. One or more LED lights can be positioned underneath the pipe to provide a display of color, which can be activated, such as when the voice-assistant has been activated or when a user is speaking.

A frame 613 can hold the components, such as the seal 605, charging coil 606, spacer 607, light pipe 602, printed circuit board 608, tape 609, and battery 610. In one embodiment, the display 603 can cover the frame 613 and the components within the frame 613. A back cover or layer of adhesive 614 can be affixed on a bottom surface of the frame 613, opposite the display, to affix the external processing system 601 to the host device. The adhesive 614 can include glue, wax, tape, or hook and loop material, as well as other type of adhesives.

In lieu or in addition to the adhesive, a telescoping base (not shown) can be affixed directly to the frame 613. The telescoping base can allow the external processing system 601 to move away and towards the host device. The adhesive can then be provided on a back surface of telescoping base to affix the base and external smart processing system to the host device.

When the external processing system 601 is included in the host device itself, not all components of the standalone external processing system are necessary. Generally, at a minimum, the printed circuit board assembly and the battery are required to communicate with and send instructions to a voice-assistant on the host device.

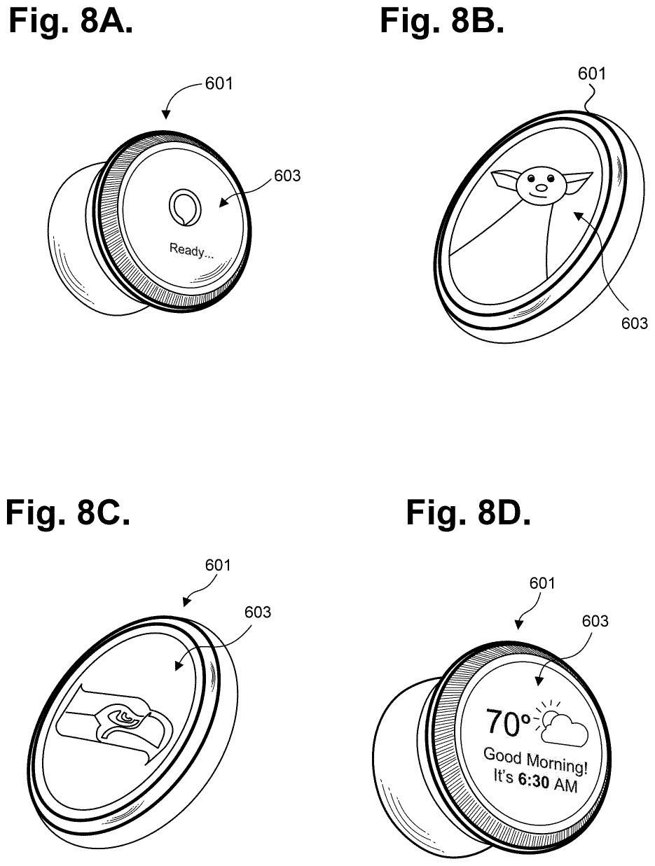

The content provided by the display can include static or dynamic images. FIGS. 8A-D are block diagrams showing, by way of example, different content displayed by the display of the processing system. The content can include an indication that input audio is being received, as shown in FIG. 8A. For example, when using the voice assistant feature of the processing system 601, the display 603 can provide content consistent with current voice assistants. The display 603 can also provide static data, such as shown in FIGS. 8B and 8C. The static images can be displayed even when the mobile device (not shown) and the processing system 601 are asleep. For example, the display can always remain on even though the mobile device is asleep. The static displays can include emojis, images, or pictures, as well as other types of static displays. The static images can be obtained from an application downloaded on the mobile device or stored locally on the mobile device. Once selected, the static image can be displayed until the user selects a different image for display. Dynamic data, such as weather and time, can also be displayed, as shown in FIG. 8D. Dynamic data can include notifications, as well as videos and scrolling texts. Other types of content are also possible.

The display 603 can also be used for taking high quality “selfies” or self-portraits. Currently, most mobile phones have a camera on the back surface and on the front surface, which is where the phone screen is located. When taking a selfie, the front camera is used so that the individual taking the selfie can see the image being captured. All other pictures are usually taken with the back camera, while the individual uses the screen to view the image, since the back camera generally takes better quality pictures. When the processing system 601 is affixed to the back of the mobile phone or a case of the mobile phone, an individual can take a selfie with the back camera by looking at the display to view the image that is to be captured. Further, individual pictures of different people can be taken and then added together to create a single image.

As described above, the processing system can also be used to locate the mobile device. To locate the device, location services, such as a mesh network, Bluetooth, GPS, Sigfox, and radio frequency can be used, as well as other types of location services. The location services can be provided on the mobile device or can be utilized via a component external to the mobile device, such as a location tracker from Tile of San Mateo, Calif. Other external location trackers and devices can be used.

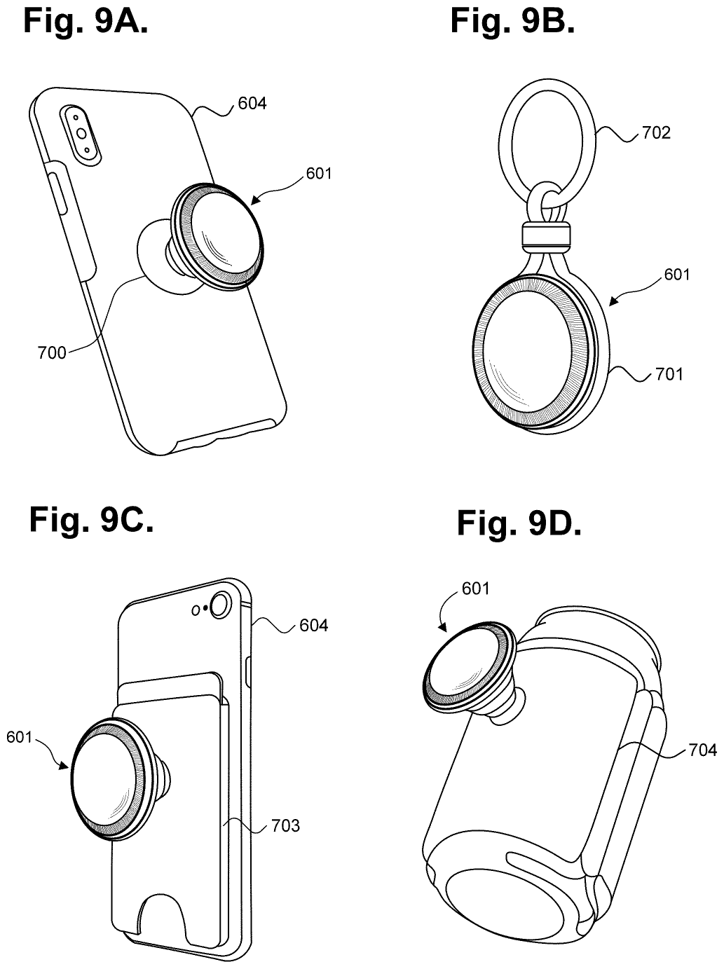

Although the processing system has been described above as being affixed to a back of a mobile device or case housing the mobile device, the processing system can also be utilized separate from a mobile device or on other types of devices. FIGS. 9A-D are block diagrams, showing by way of example, different housings or frames to hold the processing system. A mobile device case can be customized to house the processing system so that the processing system does not extend so far out when placed on a back of the case. For example, as shown in FIG. 9A, a case for a mobile phone 604 can include a cutout 700 in a shape of the processing system 601 so that the processing system fits within the case and doesn't extend too far out.

As provided in FIG. 9B, the processing system 601 can also be affixed to a frame 701 and attached to a key ring 702 or carabiner, which can be attached to a backpack, zipper, jacket, or other piece of equipment or clothing close to the user. Although separated from the mobile device, the processing system can communicate with the mobile device to obtain a reply to the user's commands or requests.

In a further embodiment, a credit card or other type of holder 703 can be attached to a back of the mobile device 604 case. The processing system can then be affixed to the holder, as provided in FIG. 9C. Additionally, the processing system 601 can be affixed to a case for a different device or component, than the mobile device. For example, FIG. 9D shows the processing system affixed to a case 704 for holding a beverage. As described above with respect to FIG. 9B, the processing system 601 communicates with a mobile device that is within a threshold distance from the processing system to allow communication. The processing system can also be affixed to different devices and cases.

Although the above description is focused on the external processing system communicating with a mobile device as the host device, other devices are possible, including server computer systems, desktop computer systems, laptop computer systems, tablets, netbooks, personal digital assistants, televisions, cameras, automobile computers, electronic media players, voice-based devices, image-based devices, cloud-based systems, artificial intelligence systems, and wearable devices, such as smart watches, headsets, ear buds, and clothing. Other types of devices are also possible. With respect to use of the processing system with a server, the processing system can instruct the server to shut down or determine a location of the server, as well as provide other types of instructions.

In one embodiment, the external processing system can work with more than one application or voice assistant. A user can enter the different applications or voice assistants for use with the external processing system in a voice assistant application associated with the external processing system, along with a “wake” word for each of the entered applications or voice assistants, if one is not already established. Once entered, the processing system can connect to the application or voice assistant for providing information or performing an action requested by the user. The processing system can be used to provide instructions to computers, such as desktop computers, laptops, tablets, or netbooks, such as to send an email or check a calendar, as well as many other actions. With respect to each of the host devices with which the processing system communicates, the processing system can be integrated into the host device, attached to an external surface of the host device, or utilized as a standalone device positioned remotely from the host device.

The applications with which the processing system communicates can include any third party voice assistant technology, home security and home management applications, educational services, travel or transportation services, including Tesla vehicle management, autonomous vehicles, restaurant and hotel reservations, and flight reservations. The applications can also include social media, video or image-based applications, calendar and time management applications, financial applications, including banking, crypto currency and NFTs, and health management applications. Other types of applications are possible.

With respect to health care, medical professionals can utilize the processing system to, for example, obtain information about a patient, determine when to deliver a next dose of medication for a patient, or submit a prescription for a patient. With respect to transportation or travel, a user can order a ride share car, or book a hotel, restaurant or activity reservation. For example, using a “wake” word associated with the application for a particular service, a user may say “Mighty Car, call me a car for pick up at 5^{th} and Union.” The phase “Mighty Car” would be recognized by the processing system as a “wake” work for the car service application, such as while a host device is asleep, and provides the request to the service application within which a car is called for the user.

In another example, a home security or management application can be accessed via the processing system to receive instructions to turn off a light, turn off a television, raise the blinds, or perform many other actions. For instance, a user getting ready to board a plane can provide instructions to turn on the porch light so the house looks occupied. In a further example, an established voice-assistant can be used, such as Alexa, by Google, to order more dog food when the user is at the dog park and remembers that there is only one serving left at home. Additionally, a user on a bike ride, can obtain directions to a restaurant in a hands-free manner, using the processing system, which is attached to the user's back pack. Information requested by or obtained for the user can be displayed on the processing system. For instance, the directions can be provided on the display, such as in a step-by-step manner, or confirmation of the dog food order can be displayed. The information to be displayed can be selected by the user or by the owner of an application from which the information is obtained.

In yet a further example, the processing system, when positioned on the back of a mobile device, can be utilized to take a selfie with the back side camera by displaying the image on the display of the processing system prior to taking the selfie. Alternatively, details about the image, such as the geotag or location can be displayed on the display of the external processing system. Many other examples and uses of the processing system are possible.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited to the embodiments of the present disclosure.

What is claimed is:

1. A voice-enabled external smart battery processing system, comprising:
at least one sensor comprising a microphone and configured to identify an input audio signal from a user;
a low-power processor configured to process the input audio signal and initiate a voice assistant session for a host device;
a battery configured to provide power to the processor and the host device; and
a display to provide visual output based on the input audio signal.

2. A voice-enabled external smart battery processing system according to claim 1, further comprising:
a light pipe surrounding an outer perimeter of the display.

3. A voice-enabled external smart battery processing system according to claim 1, further comprising:
a housing to surround the sensor, low-power processor, and battery.

4. A voice-enabled external smart battery processing system according to claim 3, wherein the display is provided on a top surface of the housing.

5. A voice-enabled external smart battery processing system according to claim 4, further comprising:
a layer of adhesive positioned on a bottom surface of the housing, opposite the display.

6. A voice-enabled external smart battery processing system according to claim 3, further comprising:
a telescoping base on which the housing is affixed.

7. A voice-enabled external smart battery processing system according to claim 3, wherein the housing is affixed to one of a mobile device, a mobile device cover, a key chain, a wallet, and a cupholder.

8. A voice-enabled external smart battery processing system according to claim 3, wherein the sensor, low-power processor, and battery are incorporated in the host device.

9. A voice-enabled external smart battery processing system according to claim 1, wherein the display provides a static or dynamic image.

10. A voice-enabled external smart battery processing system according to claim 1, wherein the low-power processor communicates with the host device via the voice assistant session to provide information or perform an action requested by user.

11. A smart battery system, comprising:
an external system, comprising:
at least one sensor comprising a microphone and configured to identify an input audio signal;
a processor configured to process the input audio signal and initiate a voice assistant session for a host device in a standby or off mode of operation, wherein the external system is associated with the host device;
a battery configured to provide power to the processor and the host device;
a speaker to provide feedback from the host device in response to the input audio signal; and
a display affixed to an outer surface of the external system and configured to provide visual output based on the input audio signal.

12. A smart battery system according to claim 11, further comprising:
a light pipe surrounding an outer perimeter of the display.

13. A smart battery system according to claim 11, further comprising:
a housing to surround the sensor, processor, and battery.

14. A smart battery system according to claim 13, wherein the display is provided on a top surface of the housing.

15. A smart battery system according to claim 14, further comprising:
a layer of adhesive positioned on a bottom surface of the housing, opposite the display.

16. A smart battery system according to claim 13, further comprising:
a telescoping base on which the housing is affixed.

17. A smart battery system according to claim 13, wherein the housing is affixed to one of a mobile device, a mobile device cover, a key chain, a wallet, and a cupholder.

18. A smart battery system according to claim 11, wherein the external system is affixed to the host device.

19. A smart battery system according to claim 11, wherein the display provides a static or dynamic image.

20. A smart battery system according to claim 11, wherein the processor communicates with the host device via the voice assistant session to provide information or perform an action requested by user.
